(19) United States
(12) Patent Application Publication
(10) Pub. No.: US 2025/0123122 A1
(43) Pub. Date: Apr. 17, 2025

(54) PRESSURE SENSOR USING MAGNETIC FIELD

(71) Applicant: CK MATERIALS LAB CO., LTD., Ansan-si, Gyeonggi-do (KR)

(72) Inventors: One Jae SUL, Ansan-si, Gyeonggi-do (KR); Jeen Gi KIM, Ansan-si, Gyeonggi-do (KR); Hyeong Jun KIM, Ansan-si, Gyeonggi-do (KR)

(21) Appl. No.: 18/686,449

(22) PCT Filed: Sep. 14, 2023
(86) PCT No.: PCT/KR2023/013777

§ 371 Date: Feb. 26, 2024

(30) Foreign Application Priority Data
Sep. 16, 2022 (KR) 10-2022-0117062
Sep. 11, 2023 (KR) 10-2023-0120362

(51) Int. Cl. G01D 5/14; G01L 1/12

(52) U.S. Cl. CPC G01D 5/145; G01L 1/12

(57) ABSTRACT

The present invention relates to a pressure sensor using a magnetic field. The pressure sensor using a magnetic field of the present invention includes an elastic portion containing a magnetic material having remanent magnetization; and a circuit portion configured to generate a Hall voltage in response to a change in a magnetic field, wherein when at least a portion of the elastic portion is deformed due to external pressure, causing a change in the magnetic field acting on the circuit portion, the circuit portion detects a magnitude of the Hall voltage corresponding to the change in the magnetic field.

### TECHNICAL FIELD

The present invention relates to a pressure sensor using a magnetic field. More specifically, the present invention relates to a pressure sensor using a magnetic field that can operate without requiring an electrical connection between an electrode and a material subjected to pressure through the remote action of a magnetic field.

### BACKGROUND ART

Various pressure sensors for sensing input intensity are provided. As shown in FIG. 1, conventional pressure sensors include a piezoresistive pressure sensor [(a) in FIG. 1], a capacitive pressure sensor [(b) in FIG. 1], a piezoelectric pressure sensor [(c) in FIG. 1], according to their operational principles.

In particular, piezoresistive and capacitive pressure sensors are widely used due to their simple operational principles and easy manufacturing processes. A piezoresistive pressure sensor senses changes in resistance values corresponding to variations in externally applied pressure F. A capacitive pressure sensor senses changes in electrical capacitance C due to variations in thickness d caused by pressure F. A piezoelectric pressure sensor senses changes in polarization according to variations in externally applied pressure F.

Such conventional pressure sensors as described above use electric fields and electrical resistance and require electrodes to be attached to both ends of the material that reacts to pressure, which can be cumbersome. In other words, since electrical wiring must necessarily be provided at both ends of the material that reacts to pressure, the product may be complicated in configuration or there may be constraints in product design.

### DETAILED DESCRIPTION OF THE INVENTION

### Technical Problem

An object of the present invention is to provide a pressure sensor using a magnetic field as a new pressure sensing method, which is not possible with conventional pressure sensors.

Additionally, another object of the present invention is to provide a pressure sensor using a magnetic field that can operate without requiring an electrical connection between an electrode and a material subjected to pressure through the remote action of a magnetic field.

Moreover, another object of the present invention is to provide a pressure sensor using a magnetic field, with improved freedom in product design.

However, these objects are exemplary and the scope of the present invention is not limited thereto.

### Technical Solution

The above objects are achieved by a pressure sensor using a magnetic field, including: an elastic portion containing a magnetic material having remanent magnetization; and a circuit portion configured to generate a Hall voltage in response to a change in a magnetic field, wherein when at least a portion of the elastic portion is deformed due to external pressure, causing a change in the magnetic field acting on the circuit portion, the circuit portion detects a magnitude of the Hall voltage corresponding to the change in the magnetic field.

In addition, the above objects of the present invention are achieved by a pressure sensor using a magnetic field, including: an elastic portion containing a magnetic material having remanent magnetization; a first circuit portion configured to generate a Hall voltage in response to a change in a magnetic field; and a second circuit portion configured to generate current through induced electromotive force in response to a change in a magnetic field, wherein when at least a portion of the elastic portion is deformed due to external pressure, causing a change in the magnetic field acting on the first circuit portion and the second circuit portion, the first circuit portion detects a magnitude of the Hall voltage corresponding to the change in the magnetic field and the second circuit portion detects a change in current corresponding to the change in the magnetic field.

According to an embodiment of the present invention, a spacer may be interposed between the elastic portion and the circuit portion.

According to an embodiment of the present invention, a spacer may be interposed between the elastic portion and the first circuit portion or the second circuit portion.

According to an embodiment of the present invention, the spacer may provide a space for a portion of the elastic portion to move when external pressure acts on the elastic portion.

According to an embodiment of the present invention, the Hall voltage may be generated by a potential difference resulting from the deflection of free electrons of a conductor in the circuit portion due to the change in the magnetic field.

According to an embodiment of the present invention, the magnitude of the Hall voltage may increase as a distance between the elastic portion and the circuit portion decreases.

According to an embodiment of the present invention, the magnitude of the pressure applied to the elastic portion may be detected through the first circuit portion, and a rate of change in the pressure applied to the elastic portion may be detected through the second circuit portion.

The elastic portion may be disposed on a first side of the circuit portion and a substrate portion may be disposed on a second side opposite to the first side of the circuit portion.

According to an embodiment of the present invention, the elastic portion may be disposed on the first side of the first circuit portion, the second circuit portion may be disposed at a predetermined distance from the second side opposite to the first side of the first circuit portion, and a substrate portion may be disposed on a second side opposite to a first side of the second circuit portion facing the first circuit portion.

According to an embodiment of the present invention, the pressure sensor may further include a coil portion configured to provide the elastic portion as an actuator by applying a second magnetic field to the elastic portion.

In addition, the above objects of the present invention are achieved by a touch sensor including one or a plurality of pressure sensors using a magnetic field described above.

### Advantageous Effects

According to the present invention configured as described above, there is an effect of providing a pressure sensor using a magnetic field as a new pressure sensing method, which is not possible with existing pressure sensors.

In addition, according to the present invention, a pressure sensor using a magnetic field is capable of remotely sensing pressure without requiring an electrical connection between an elastic portion containing magnetic particles and a circuit portion detecting changes in a magnetic field, due to the deformation and restoration of the elastic portion containing the magnetic particles corresponding to the presence, absence, and changes in pressure applied to the sensor, which causes spatiotemporal changes in the intensity of the magnetic field.

Moreover, according to the present invention, it is possible to operate without an electrical connection between the elastic portion containing magnetic particles and the circuit portion, and since electrodes of the circuit portion exist on a single substrate and there is no need to connect the electrodes to both ends of the elastic portion containing magnetic particles, integration with other microelectronic circuits on the same substrate, other than the pressure sensor using a magnetic field, is facilitated, leading to advantages in applications to the Internet of Things (IoT), where integration of sensors and information processing circuits is preferable.

However, the scope of the present invention is not limited by such an effect.

### BRIEF DESCRIPTION OF DRAWINGS

FIG. 1 is a schematic diagram illustrating pressure sensors using existing pressure sensing methods.

FIGS. 2 and 3 are schematic diagrams illustrating a pressure sensor using a magnetic field and a driving process thereof according to a first embodiment of the present invention.

FIG. 4 is a schematic diagram illustrating the operational principle of the pressure sensor using a magnetic field according to the first embodiment of the present invention.

FIG. 5 is a schematic diagram illustrating a pressure sensor using a magnetic field and a driving process thereof according to a second embodiment of the present invention.

FIG. 6 is a schematic diagram illustrating the operational principle of the pressure sensor using a magnetic field according to the second embodiment of the present invention.

FIGS. 7 and 8 are schematic diagrams illustrating a pressure sensor using a magnetic field and a driving process thereof according to a third embodiment of the present invention.

FIG. 9 is a schematic diagram illustrating the operational principle of the pressure sensor using a magnetic field according to the third embodiment of the present invention.

FIG. 10 is a schematic diagram illustrating an application example of using a pressure sensor using a magnetic field in accordance with an embodiment of the present invention as an actuator.

FIG. 11 is a schematic diagram illustrating a pressure sensor using a magnetic field and a driving process thereof according to a fourth embodiment of the present invention.

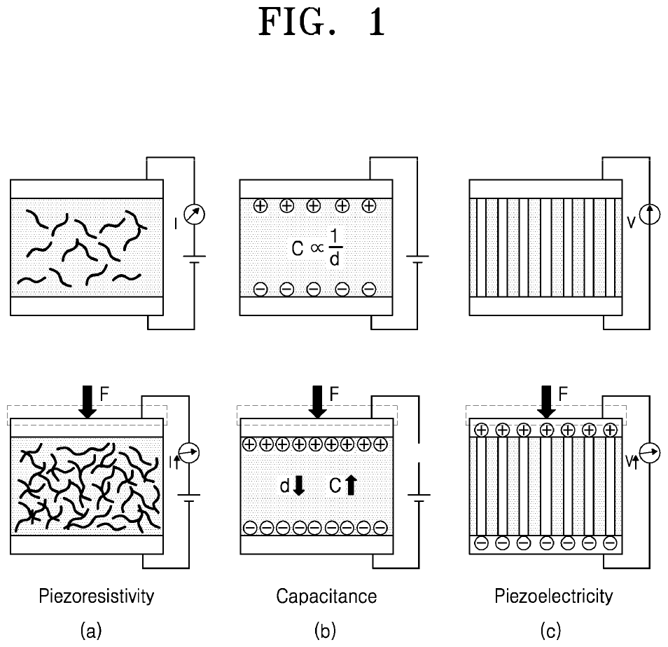

### REFERENCE NUMERALS

100, 200, 300, 400: Pressure sensor using magnetic field
110, 210, 310, 410: Elastic portion
120, 220, 320, 420: Spacer
130, 330, 430: Circuit portion, first circuit portion
250, 350, 450: Circuit portion, second circuit portion
140, 240, 340, 440: Substrate portion

### Mode for Invention

In the following detailed description, reference is made to the accompanying drawings that show, by way of illustration, embodiments in which the invention may be practiced. These embodiments are described in sufficient detail to enable those skilled in the art to practice the invention. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, similar reference numerals refer to the same or similar functions over various aspects, and the length, area, thickness, and the like and the form may be exaggerated for convenience.

Hereinafter, preferred embodiments of the present invention will be described in detail with reference to the accompanying drawings so that those skilled in the art may easily implement the present invention.

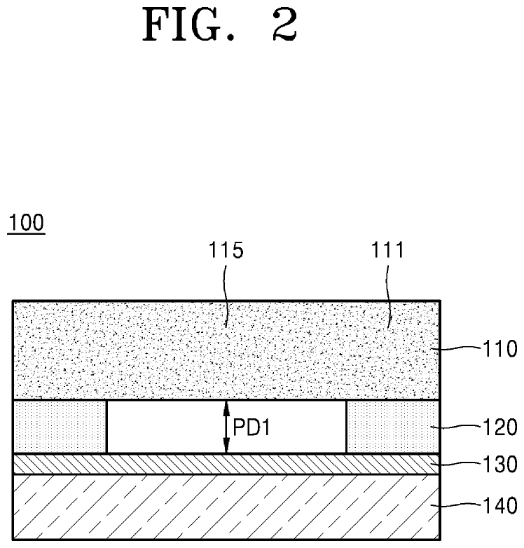

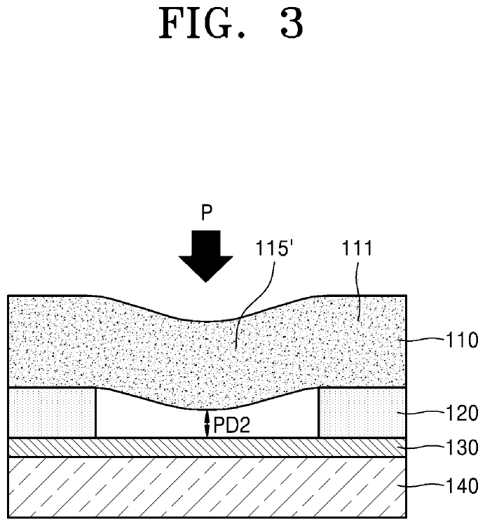

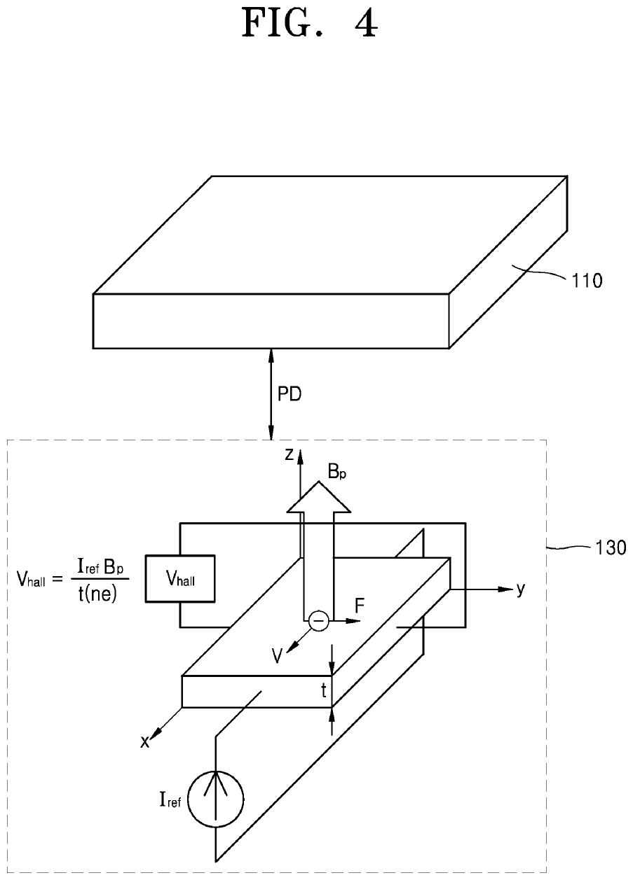

FIGS. 2 and 3 are schematic diagrams illustrating a pressure sensor 100 using a magnetic field and a driving process thereof according to a first embodiment of the present invention. FIG. 4 is a schematic diagram illustrating the operational principle of the pressure sensor 100 using a magnetic field according to the first embodiment of the present invention.

Referring to FIGS. 2 and 3, the pressure sensor 100 using a magnetic field according to the first embodiment may be provided as a static pressure sensor using an elastic portion 110 containing magnetic particles. The pressure sensor 100 may include the elastic portion 110 and a circuit portion 130. Additionally, a spacer 120 and a substrate portion 140 may be further included. The elastic portion 110, spacer 120, and circuit portion 130 may be provided in a thin film through a semiconductor manufacturing process.

The elastic portion 110 may have remanent magnetization. The elastic portion 110 may retain magnetism even after an external magnetic field is removed following exposure to the external magnetic field.

The elastic portion 110 may contain magnetic particles. The elastic portion 110 may include an elastic material in which magnetic particles are dispersed in a matrix. For example, the elastic portion 110 may include at least one magnetorheological elastomer (MRE) and may itself be composed of a magnetorheological elastomer.

The magnetic particles may be at least one selected from iron, carbonyl iron, iron alloy, iron oxide, iron nitride, iron carbide, low carbon steel, nickel, cobalt, and mixtures thereof, or alloys thereof. Additionally, the magnetic particles may be uncoated or coated with an organic resin. Furthermore, the magnetic particles may include neodymium (Nd)-based materials such as FeNdB. The matrix material may be any polymer such as natural rubber, synthetic rubber, etc.

According to one embodiment, the elastic portion 110 may include a support portion 111 connected to other components to support the elastic portion 110, and a deformable portion 115 connected integrally with the support portion 111 and capable of deformation or positional change. The support portion 111 may not contain magnetic particles, while only the deformable portion 115 may contain magnetic particles.

The elastic portion 110 may be at least in a magnetized state due to the magnetic particles. Consequently, the elastic portion 110 may exhibit a magnetic field. In addition, the elastic portion 110 may undergo changes in characteristics such as stiffness, tensile strength, and elongation as a result of the reaction of the magnetic particles to an external magnetic field applied. Furthermore, the shape of the elastic portion 110 itself may be deformed as the magnetic particles react to the application of an external magnetic field.

In addition to sheet or thin film forms, the elastic portion 110 may be configured in various forms, without limitations, as long as it has properties of elasticity and remanent magnetization and can apply a magnetic field to the circuit portion 130.

The spacer 120 may provide a gap PD1 between the elastic portion 110 and the circuit portion 130. The spacer 120 may have a predetermined thickness and be placed between one side of the elastic portion 110 and one side of the circuit portion 130. Additionally, the spacer 120 may provide a space for a portion of the elastic portion 110 (e.g., deformable portion 115) to move when pressure P is applied to the elastic portion 110.

The circuit portion 130 may generate a Hall voltage when the applied magnetic field changes. The circuit portion 130 may be a Hall effect sensor, which may be provided as metal or semiconductor wires.

The pressure sensor 100 using a magnetic field according to the present invention operates on the Hall effect principle. The Hall effect will be described below with reference to FIG. 4.

Initially, when a current I_{ref} flows through a conductor, free electrons move in the opposite direction of the current. When a magnetic field Bₚ is applied or brought to the conductor, the free electrons that move according to the Hall effect experience the Lorentz force according to Fleming's left-hand rule, and are deflected. As a result of the Hall effect, a potential difference is generated, and Hall voltage Vₕₐₗₗ is formed by this electromotive force. When the moving direction of the current or the direction of the magnetic field changes, the Hall effect and Hall voltage also change accordingly.

Hall voltage may be expressed as

$${V}_{hall} = \frac{{I}_{ref} {B}_{p}}{tne} .$$

For example, when I_{ref} is approximately 1 mA, Bₚ is approximately 600 Gauss, n is approximately 10²² m⁻³ (doped silicon, N_{d} is approximately 10¹⁶), and t is approximately 100 nm, V_{Hall} may be approximately 60 mV.

The magnetic field applied to the circuit portion 130 may vary depending on whether the distance PD between the elastic portion 110 and the circuit portion 130 increases or decreases, and a Hall voltage may be generated accordingly.

As illustrated in FIG. 3, pressure P may be applied to the elastic portion 110. Thus, a portion of the elastic portion 110 may deform (115->115′) causing the distance PD to decrease between the elastic portion 110 and the circuit portion 130 (PD1->PD2). Consequently, a magnetic field may be applied from the elastic portion 110 to the circuit portion 130. Since the elastic portion 110 may exhibit a magnetic field in a magnetized state, the intensity of the applied magnetic field increases as it approaches the circuit portion 130, resulting in an increase in Hall voltage V_{Hall}. Thus, a correlation between the pressure P applied to the elastic portion 110 and an output signal V_{Hall} of the circuit portion 130 is established. The circuit portion 130 may detect the pressure P applied to the elastic portion 110 by measuring the magnitude of the Hall voltage V_{Hall}.

The substrate portion 140 may be provided to support each component of the pressure sensor 100 using a magnetic field. Since a target object (not shown) to which the pressure sensor 100 is connected may have various forms, including three-dimensional shapes, it is preferable for the substrate portion 140, which is connected to the target object, to be made of a flexible material. However, the substrate portion 140 is not necessarily limited to flexible materials, as the target object may have a planar shape or may be made of materials that are difficult to connect with flexible materials.

The substrate portion 140 may be disposed below the circuit portion 130 to support it. The pressure sensor 100 may be constructed by stacking the substrate portion 140, the circuit portion 130, the spacer 120, and the elastic portion 110 in that order. From another perspective, the elastic portion 110 may be disposed on a first side (e.g., top side) of the circuit portion 130, and the substrate portion 140 may be disposed on a second side (e.g., bottom side) opposite to the first side.

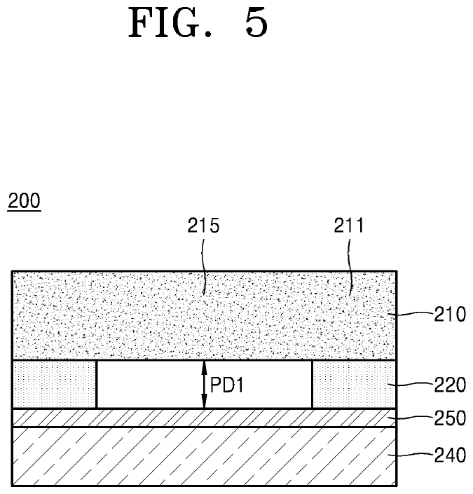

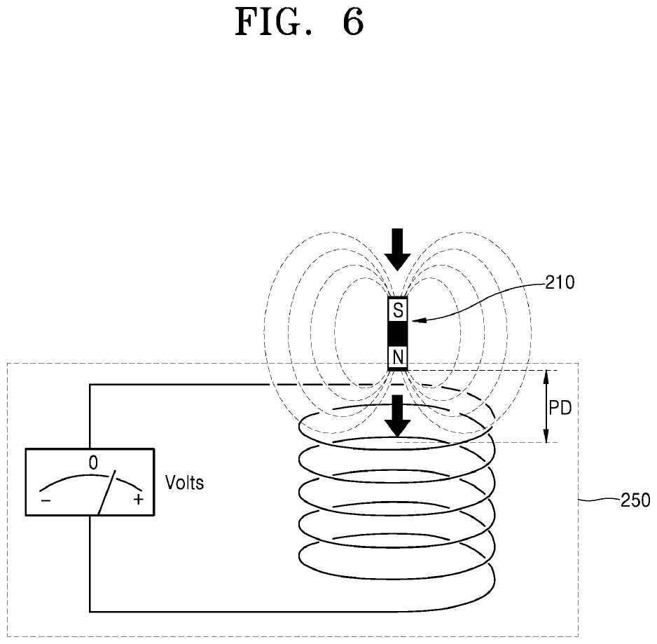

FIG. 5 is a schematic diagram illustrating a pressure sensor 200 using a magnetic field and a driving process thereof according to a second embodiment of the present invention. FIG. 6 is a schematic diagram illustrating the operational principle of the pressure sensor 200 using a magnetic field according to the second embodiment of the present invention. Only elements different from those of the first embodiment of FIGS. 2 to 4 will be described in the descriptions of FIGS. 5 and 6 and the same elements will not be repeatedly described herein. The same elements in the first and second embodiments are denoted by reference numerals 100s and 200s and correspond to each other.

Referring to FIG. 5, a pressure sensor 200 using a magnetic field according to the second embodiment may include an elastic portion 210 and a circuit portion 250. Additionally, a spacer 220 and a substrate portion 240 may be further included. The elastic portion 210, the spacer 220, and the substrate portion 240 are substantially identical to the above-described elastic portion 110, spacer 120, and substrate portion 140, respectively.

As illustrated in FIG. 6, the pressure sensor 200 using a magnetic field according to the second embodiment may use magnetic induction. The structure is similar to that of FIG. 2, but the elastic portion 210 may generate electromotive force F due to magnetic induction on the wires of the circuit portion 250 as it is subjected to P.

The electromotive force ε may be calculated as

$$ε = - \frac{d}{dt} {\int }_{\sum } B \cdot dA .$$

For example, if Bₚ is approximately 600 Gauss, A is approximately 10⁻⁴ m² (the area enclosed by the circuit wires when one side of the circuit wire is approximately 1 cm), and ΔBₚ, which is a change in the magnetic field acting on the circuit when a change in pressure occurs over approximately 1 second, is 600 Gauss, F may be approximately 6 V.

The magnetic field applied to the circuit portion 250 may vary depending on whether the distance PD between the elastic portion 210 and the circuit portion 250 increases or decreases, and induced electromotive force may be generated accordingly. The circuit portion 250 may be a magnetic induction sensor or a Lorentz force sensor, which may be provided as loop-shaped metal or semiconductor wires.

Since the elastic portion 210 may exhibit a magnetic field in a magnetized state, a change in the magnetic field as the elastic portion 210 approaches or moves away from the circuit portion 250 may cause induced electromotive force F, which in turn forms a current. The circuit portion 250 may measure the change in current to detect the rate of change in the pressure P applied to the elastic portion 210.

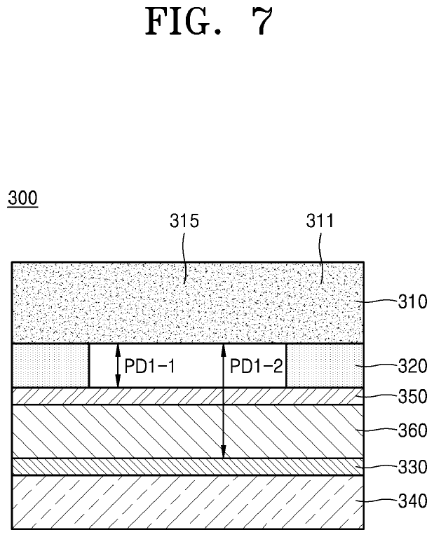

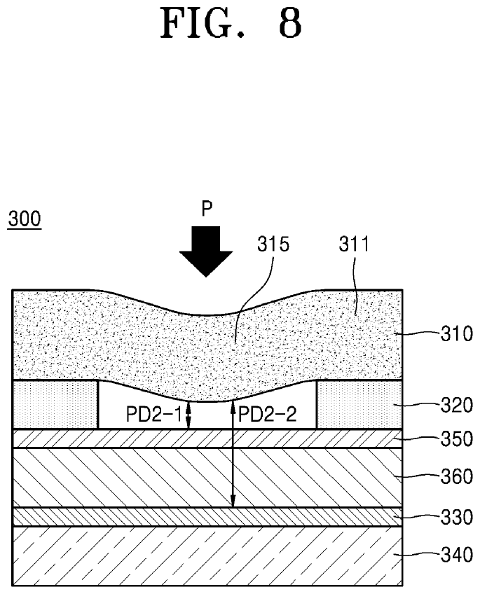

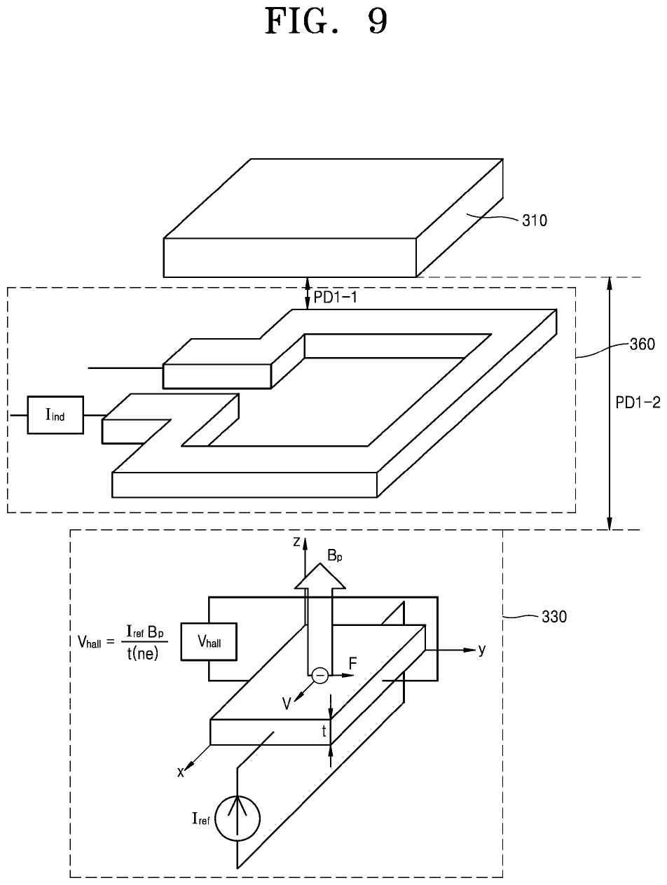

FIGS. 7 and 8 are schematic diagrams illustrating a pressure sensor 300 using a magnetic field and a driving process thereof according to a third embodiment of the present invention. FIG. 9 is a schematic diagram illustrating the operational principle of the pressure sensor 300 using a magnetic field according to the third embodiment of the present invention. Only elements different from those of the first and second embodiments will be described in the descriptions of FIGS. 7 to 9 and the same elements will not be repeatedly described herein. The same elements in the first and second embodiments are denoted by reference numerals 100s, 200s, and 300s and correspond to one another.

Referring to FIGS. 7 and 8, a pressure sensor 300 using a magnetic field according to the third embodiment may include an elastic portion 310, a first circuit portion 330, and a second circuit portion 350. Additionally, a spacer 320, a substrate portion 340, and a dielectric layer 360 may be further included. The elastic portion 310, the spacer 320, and the substrate portion 340 are substantially identical to the above-described elastic portion 110, spacer 120, and substrate portion 140, respectively. Also, the first circuit portion 330 is substantially identical to the circuit portion 130, and the second circuit portion 350 is substantially identical to the circuit portion 250.

As illustrated in FIG. 9, the pressure sensor 300 using a magnetic field according to the third embodiment may use both the Hall effect principle and magnetic induction. The third embodiment is a combination of the first and second embodiments.

The positions of the first circuit portion 330 and the second circuit portion 350 may be interchanged. As illustrated in FIG. 7, if the second circuit portion 350 is positioned above the first circuit portion 330, the spacer 320 may be interposed between the elastic portion 310 and the second circuit portion 350. The substrate portion 340 may be disposed below the first circuit portion 330.

Conversely, if the first circuit portion 330 is positioned above the second circuit portion 350, the spacer 320 may be interposed between the elastic portion 310 and the first circuit portion 330. The substrate portion 340 may be disposed below the first circuit portion 350.

The dielectric layer 360 may be interposed between the first circuit portion 330 and the second circuit portion 350.

The first circuit portion 330 may be provided as a Hall effect sensor, while the second circuit portion 350 may be provided as a magnetic induction sensor or a Lorentz force sensor. The first circuit portion 330 is spaced by PD1-1 from the elastic portion 310, and the second circuit portion 350 is spaced by PD1-2 from the elastic portion 310.

As illustrated in FIG. 8, when pressure P is applied to the elastic portion 310, a portion of the elastic portion 310 may deform and the distance to the the first circuit portion 330 and the second circuit portion 350 may decrease (PD1-1->PD2-1) (PD1-2->PD2-2). Consequently, a magnetic field may be applied from the elastic portion 310 to each of the first circuit portion 330 and the second circuit portion 350. The first circuit portion 330 may measure the magnitude of the Hall voltage V_{Hall} to detect the pressure P. Simultaneously, the second circuit portion 350 may measure a change in current generated by induced electromotive force F to detect the rate of change in the pressure P.

In this manner, the pressure sensor 300 of the third embodiment can simultaneously detect the absolute magnitude of pressure and the rate of change in pressure.

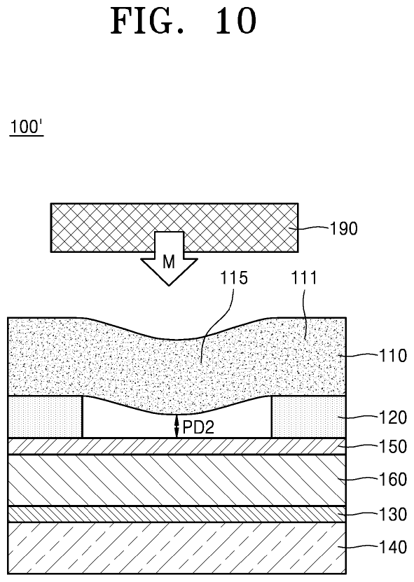

FIG. 10 is a schematic diagram illustrating an application example of using a pressure sensor 100′ using a magnetic field in accordance with an embodiment of the present invention as an actuator.

Referring to FIG. 10, a pressure sensor 100′ using a magnetic field may further include a coil portion 190 configured to apply a magnetic field to the elastic portion 110. In FIG. 10, the coil portion 190 is shown positioned above the elastic portion 110, but as long as the magnetic field affects only the elastic portion 110 without influencing the first circuit portion 130 and the second circuit portion 150, there are no limitations in the placement location.

When a magnetic field is applied to the elastic portion 110 from the coil portion 190, the elastic portion 110 may be provided as an actuator as it undergoes changes in stiffness, shape, etc., due to the applied magnetic field. The tactile sensation provided by the actuator may include vibration, tapping, twisting, as well as patterns, rhythms, and directional sensation. Since the elastic portion 110 may be composed of an elastic material containing magnetic particles, or a magnetorheological elastomer, it offers the advantage of facilitating the implementation of various tactile sensations through changes in the material's shape.

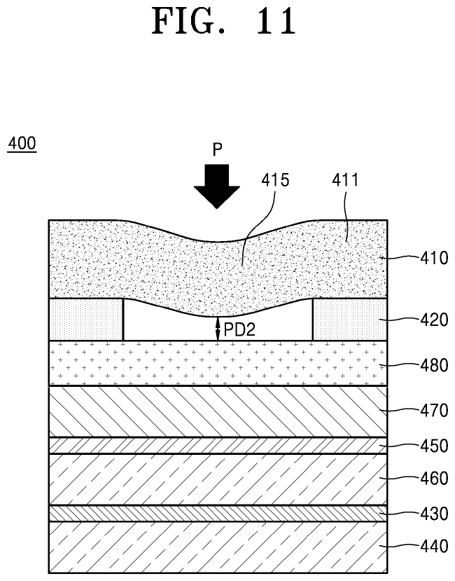

FIG. 11 is a schematic diagram illustrating a pressure sensor 400 using a magnetic field and a driving process thereof according to a fourth embodiment of the present invention. Only elements different from those of the third embodiment will be described in the descriptions of FIG. 11 and the same elements will not be repeatedly described herein. The same elements in the third and fourth embodiments are denoted by reference numerals 300s and 400s and correspond to each other.

Referring to FIG. 11, a pressure sensor 400 using a magnetic field according to the fourth embodiment may include an elastic portion 410, a spacer 420, a first circuit portion 430, a substrate portion 440, a second circuit portion 450, and a dielectric layer 460. Additionally, a circuit portion 470 may be further included irrespectively of the sensors of the first circuit portion 430 and the second circuit portion 450. The added circuit portion 470 may include an information processing circuit, a sensor power supply circuit, a USB communication circuit, a sensor signal input circuit, a wired power circuit, a battery charging circuit, a voltage control circuit, and the like. Moreover, an insulating layer 480 may be stacked on the upper part of the second circuit portion 450 to insulate the circuit portion 470 from the first and second circuit portions 430 and 450.

Furthermore, according to one embodiment, the pressure sensors 100 to 400 using a magnetic field of the present invention may be used as a touch sensor. The touch sensor may be provided in the form of one or multiple pressure sensors 100 to 400 arranged. When a specific pressure sensor detects pressure, it may be applied as a touch sensor by determining the location where the pressure sensor is placed.

As described above, the pressure sensor 100 to 400 using a magnetic field of the present invention offers a new method of pressure detection that is not possible with conventional pressure sensors. By using a magnetic field, it can operate through the remote action of the magnetic field, without the need for electrical connection between the electrodes and the elastic portion where pressure is applied. In other words, since pressure can be sensed as the elastic portion applies the magnetic force to the circuit portion, there is no need to separately connect electrodes to both ends of the elastic portion.

Moreover, as the pressure sensor can operate without requiring an electrical connection between the elastic portion where pressure is applied and the electrodes, and since the circuit portion exists on a single substrate, it facilitates integration with microelectronic circuits and offers advantages in applications to the Internet of Things (IoT) or the like.

In addition, while conventional pressure sensors can measure pressure using only either static or dynamic pressure measurement method and thus can measure only either the absolute value of pressure or rate of change in pressure, the pressure sensor of the present invention can simultaneously measure both static pressure and dynamic pressure changes using a single sensor that uses a magnetic field.

Although the present invention has been shown and described with reference to a preferred embodiment as described above, the present invention is not limited to the above embodiment, and within the scope without departing from the spirit of the present invention, various modifications and changes can be made by those skilled in the art. It should be considered that such modification example and change example belong to the scopes of the present invention and the appended claims.

1. A pressure sensor using a magnetic field, comprising:
an elastic portion containing a magnetic material having remanent magnetization;
a circuit portion configured to generate a Hall voltage in response to a change in a magnetic field,
wherein when at least a portion of the elastic portion is deformed due to external pressure, causing a change in the magnetic field acting on the circuit portion, the circuit portion detects a magnitude of the Hall voltage corresponding to the change in the magnetic field.

2. A pressure sensor using a magnetic field, comprising:
an elastic portion containing a magnetic material having remanent magnetization;
a first circuit portion configured to generate a Hall voltage in response to a change in a magnetic field; and
a second circuit portion configured to generate current through induced electromotive force in response to a change in a magnetic field,
wherein when at least a portion of the elastic portion is deformed due to external pressure, causing a change in the magnetic field acting on the first circuit portion and the second circuit portion, the first circuit portion detects a magnitude of the Hall voltage corresponding to the change in the magnetic field and the second circuit portion detects a change in current corresponding to the change in the magnetic field.

3. The pressure sensor of claim 1, wherein a spacer is interposed between the elastic portion and the circuit portion.

4. The pressure sensor of claim 2, wherein a spacer is interposed between the elastic portion and the first circuit portion or the second circuit portion.

5. The pressure sensor of claim 3, wherein the spacer provides a space for a portion of the elastic portion to move when external pressure acts on the elastic portion.

6. The pressure sensor of claim 1, wherein the Hall voltage is generated by a potential difference resulting from deflection of free electrons of a conductor in the circuit portion due to the change in the magnetic field.

7. The pressure sensor of claim 1, wherein a magnitude of the Hall voltage increases as a distance between the elastic portion and the circuit portion decreases.

8. The pressure sensor of claim 2, wherein a magnitude of the pressure applied to the elastic portion is detected through the first circuit portion, and
a rate of change in the pressure applied to the elastic portion is detected through the second circuit portion.

9. The pressure sensor of claim 1, wherein the elastic portion is disposed on a first side of the circuit portion and a substrate portion is disposed on a second side opposite to the first side of the circuit portion.

10. The pressure sensor of claim 2, wherein the elastic portion is disposed on a first side of the circuit portion, the second circuit portion is disposed at a predetermined distance from a second side opposite to the first side of the first circuit portion, and a substrate portion is disposed on a second side opposite to a first side of the second circuit portion facing the first circuit portion.

11. The pressure sensor of claim 1, further comprising a coil portion configured to provide the elastic portion as an actuator by applying a second magnetic field to the elastic portion.

12. A touch sensor comprising one or a plurality of pressure sensors using a magnetic field of claim 1.
